(19) United States
(12) Patent Application Publication
(10) Pub. No.: US 2025/0326337 A1
(43) Pub. Date: Oct. 23, 2025

(54) HIGHLY COMPATIBLE WAGON CAR SEAT ADAPTER

(71) Applicant: BRAN-NEW INTERNATIONAL CORPORATION, Seoul (KR)

(72) Inventor: Mijin KIM, Bucheon-si (KR)

(21) Appl. No.: 18/953,012

(22) Filed: Nov. 19, 2024

(30) Foreign Application Priority Data
Apr. 19, 2024 (KR) 10-2024-0052947

(51) Int. Cl. B60N 2/28; B62B 5/08; B62B 7/14

(52) U.S. Cl. CPC B60N 2/2848; B62B 5/082; B62B 7/145

(57) ABSTRACT

Provided is a highly compatible car seat adapter for wagons which is capable of stably coupling an infant car seat installed in a vehicle to an infant wagon upon arrival at a destination, whereby it is possible to provide the same ride comfort to an infant and to minimize resistance of the infant when changing from the vehicle to the infant wagon, which is enabled by mounting the infant car seat to an upper end of the infant wagon, and thus, it is possible to use the interior space of the infant wagon as a luggage carrier, which enables leisurely movement, and the car seat adapter is compatible with each of a plurality of infant car seats having various shapes and coupling structures so as to be stably separably coupled to the infant wagon, whereby it is possible to expand usability of the infant car seat.

### BACKGROUND OF THE PRESENT INVENTION

### Field of the Present Invention

The present invention relates to a highly compatible car seat adapter for wagons which is capable of stably coupling an infant car seat to an infant wagon when an infant changes from a vehicle to the infant wagon, whereby it is possible to provide the same ride comfort to the infant, and thus, the car seat adapter is compatible with each of a plurality of infant car seats having various shapes and coupling structures so as to be stably separably coupled to the infant wagon, whereby it is possible to expand usability of the infant wagon.

### Description of the Related Art

Conventionally, when going out riding in a vehicle, families with infant children install a car seat in their vehicle, fold and load the infant wagon in the trunk, and drive to their destination.

Upon arrival at the destination, the infant wagon can be taken out from the vehicle and unfolded to allow an infant to board, but there are problems such as the infant being uncomfortable in the wagon or the infant being reluctant to change from the car seat to the infant wagon.

However, the existing infant wagon does not have an adapter configured to allow a separate car seat to be coupled to the infant wagon therethrough, whereby the infant car seat is coupled only to the vehicle, and therefore a caregiver has to carry the infant wagon while the infant is sitting in the infant wagon.

In addition, if the infant has a lot carrying possessions when going out while sitting in the infant wagon, the space for storing the possessions becomes narrow, and therefore the caregiver has to carry the possessions separately, which is inconvenient.

### PRIOR ART DOCUMENT

[Patent Document]
Korean Patent Application Publication No. 10-2023-0012949 (published on Jan. 26, 2023)

### SUMMARY OF THE PRESENT INVENTION

The present invention has been made in view of the above problems, and it is an objective of the present invention to provide a highly compatible car seat adapter for wagons capable of stably coupling an infant car seat installed in a vehicle to an infant wagon upon arrival at a destination, whereby it is possible to provide the same ride comfort to an infant and to minimize resistance of the infant when the infant changes from the vehicle to the infant wagon, which is enabled by mounting the infant car seat to an upper end of the infant wagon, and thus, it is possible to use the interior space of the infant wagon as a luggage carrier, which enables leisurely movement, and the car seat adapter for wagons is compatible with each of a plurality of infant car seats having various shapes and coupling structures so as to be stably separably coupled to the infant wagon, whereby it is possible to expand usability of the infant car seat.

In accordance with the present invention, the above and other objectives can be accomplished by the provision of a highly compatible car seat adapter for wagons, wherein the car seat adapter is a frame which has a quadrangular frame structure with rounded corners, is symmetrically coupled to upper left and right ends of an infant wagon so as to have a coupling structure compatible with an infant car seat, and is configured to stably support the infant car seat coupled to the infant wagon.

### BRIEF DESCRIPTION OF THE DRAWINGS

The above and other objectives, features and other advantages of the present invention will be more clearly understood from the following detailed description taken in conjunction with the accompanying drawings, in which:

FIG. 1 is a perspective view showing an overall shape of a highly compatible car seat adapter for wagons according to the present invention;

FIG. 2 is an exploded perspective view of the highly compatible car seat adapter for wagons according to the present invention with a connection bracket being separated from the other components of the car seat adapter;

FIG. 3 is an exploded perspective view of the highly compatible car seat adapter for wagons according to the present invention with components of the car seat adapter being separated from each other;

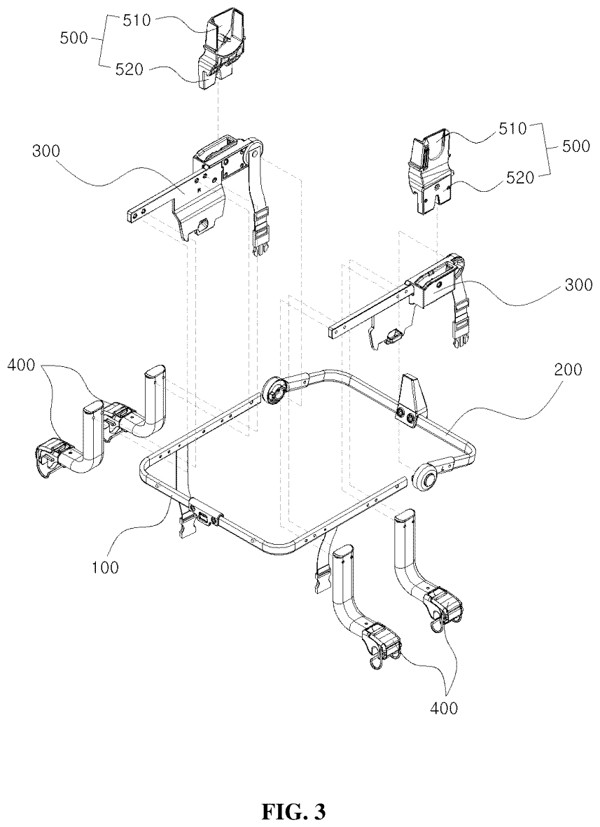

FIG. 4 is a view showing an overall shape of the highly compatible car seat adapter for wagons according to the present invention, showing an enlarged part of the highly compatible car seat adapter for wagons, and showing a state in which a fastening hook is released by opening a locking switch while a locking button of a lower fastening frame is pressed;

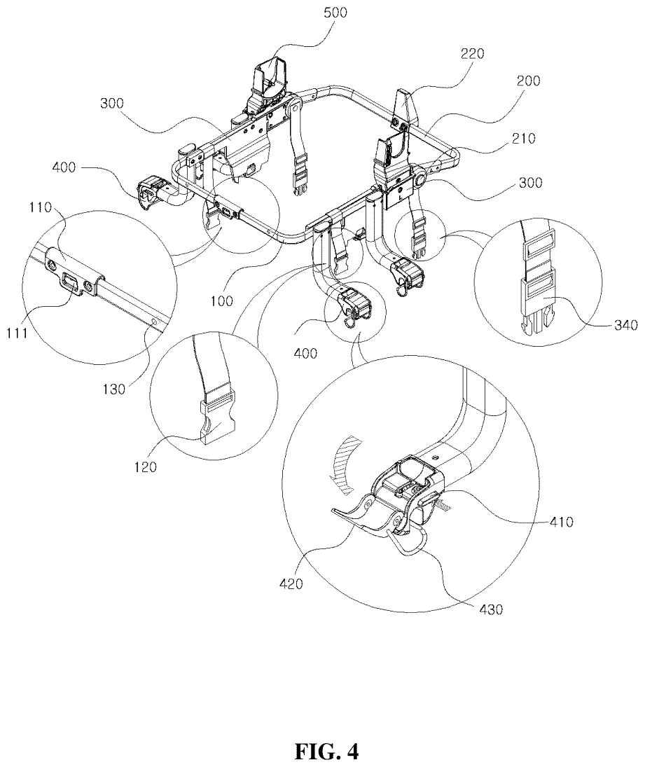

FIG. 5 is a perspective view showing a shape of a center coupling frame according to the present invention;

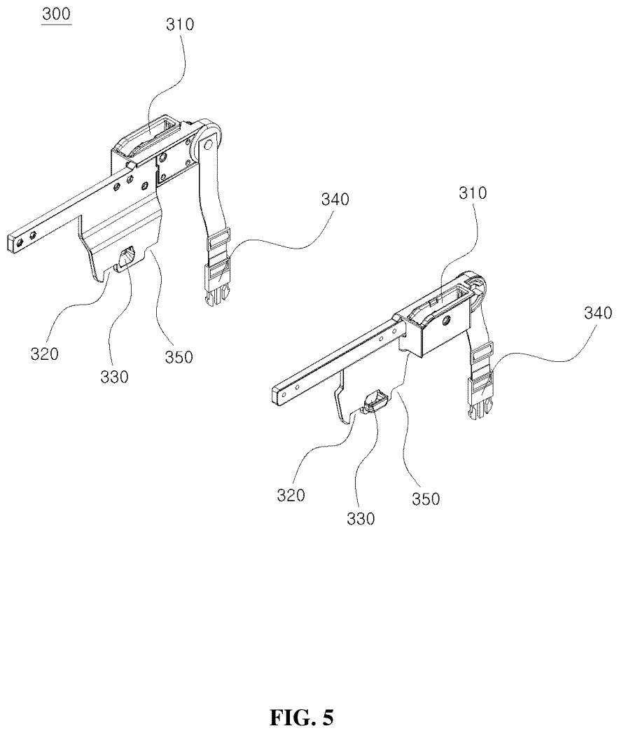

FIG. 6 is a perspective view showing a state in which the highly compatible car seat adapter for wagons according to the present invention is coupled to an infant wagon;

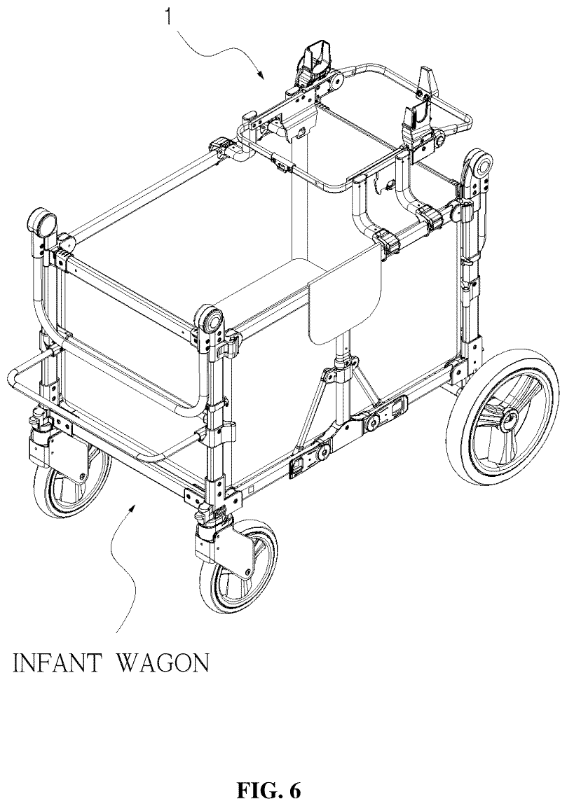

FIG. 7 is a side view showing a state in which the car seat adaptor according to the present invention is installed on the infant wagon and an A-type infant car seat is coupled to the car seat adapter, with a partial enlarged view showing a state in which a female buckle and a male buckle are not fastened to each other;

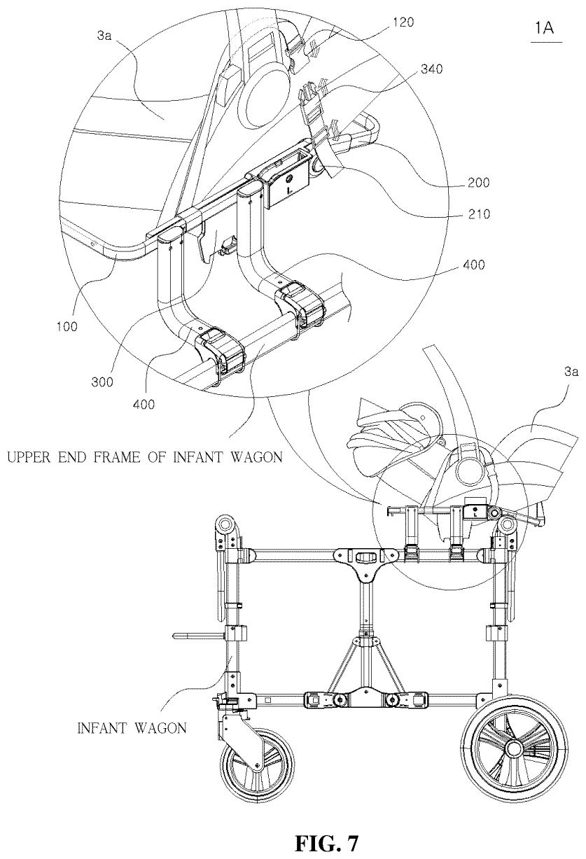

FIG. 8 is a side view showing a state in which the car seat adaptor according to the present invention is installed on the infant wagon and the A-type infant car seat is coupled to the car seat adapter, with a partial enlarged view showing a state in which the female buckle and the male buckle are fastened to each other;

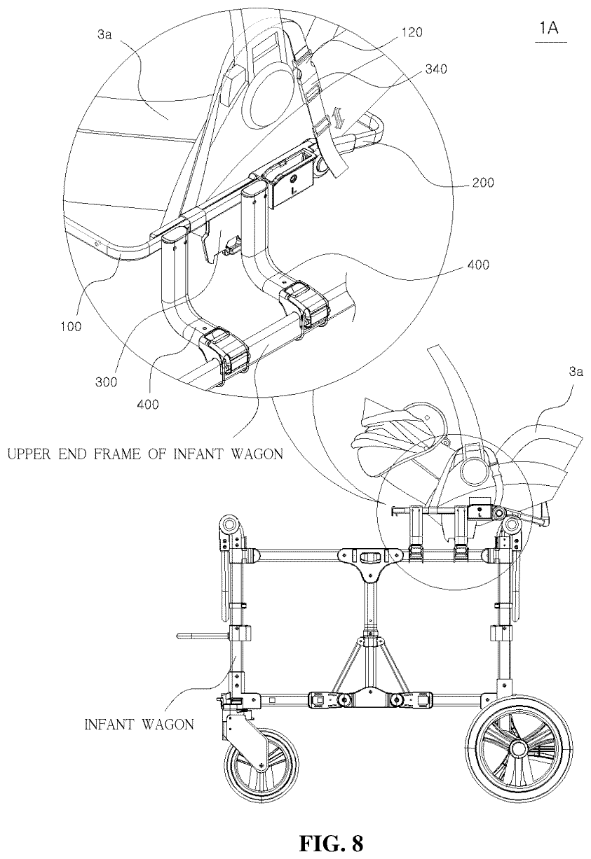

FIG. 9 is a side view showing a state in which the car seat adaptor according to the present invention is installed on the infant wagon and a B-type infant car seat is not coupled to the car seat adapter, with a partial enlarged view showing parts couplable to each other;

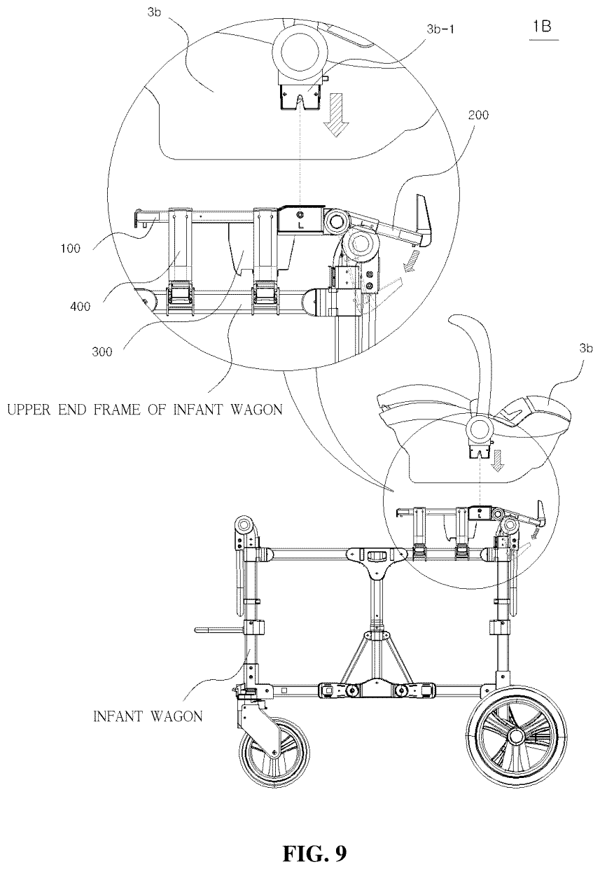

FIG. 10 is a side view showing a state in which the car seat adaptor according to the present invention is installed on the infant wagon and the B-type infant car seat is coupled to the car seat adapter, with a partial projected enlarged view showing the parts coupled to each other;

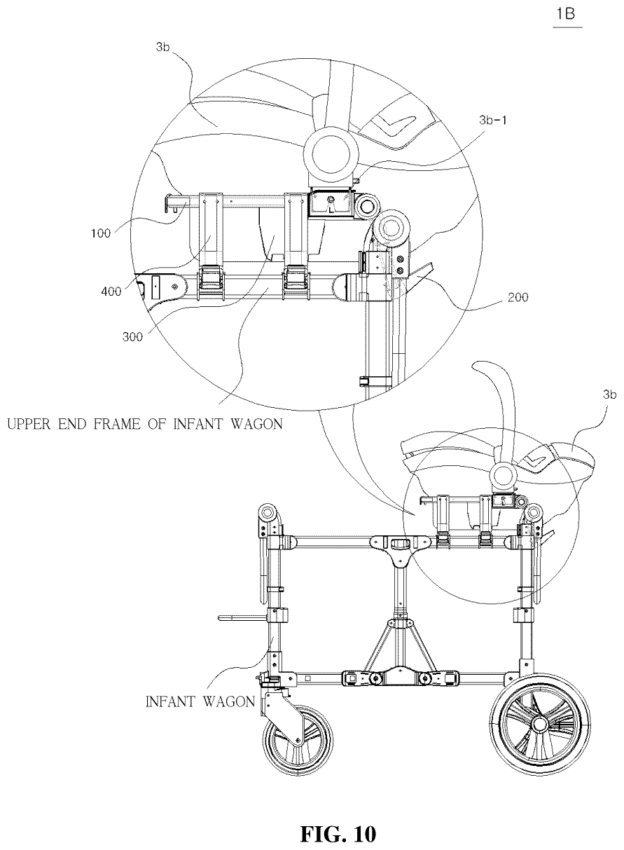

FIG. 11 is a side view showing a state in which the car seat adaptor according to the present invention is installed on the infant wagon and the B-type infant car seat is not coupled to the car seat adapter, with an isometric partial enlarged view showing the parts couplable to each other;

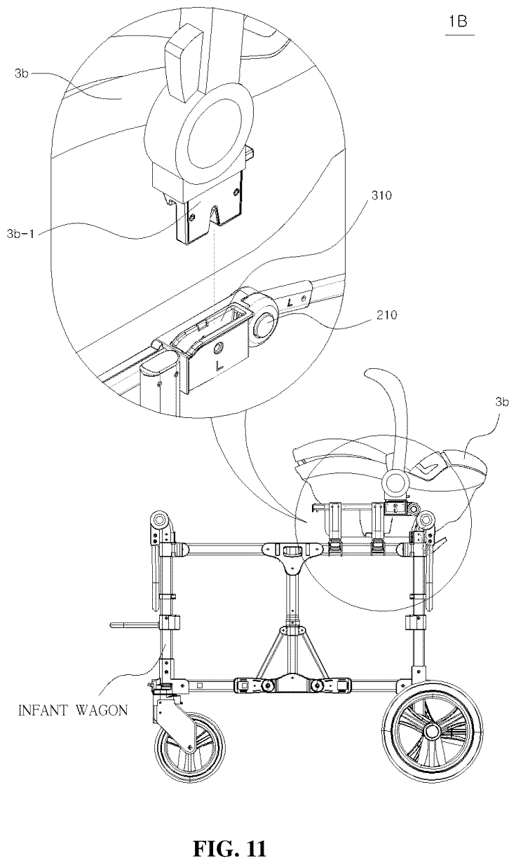

FIG. 12 is a side view showing a state in which the car seat adaptor according to the present invention is installed on the infant wagon and a C-type infant car seat is not coupled to the car seat adapter, with an isometric partial enlarged view showing a fastening protrusion of the C-type infant car seat;

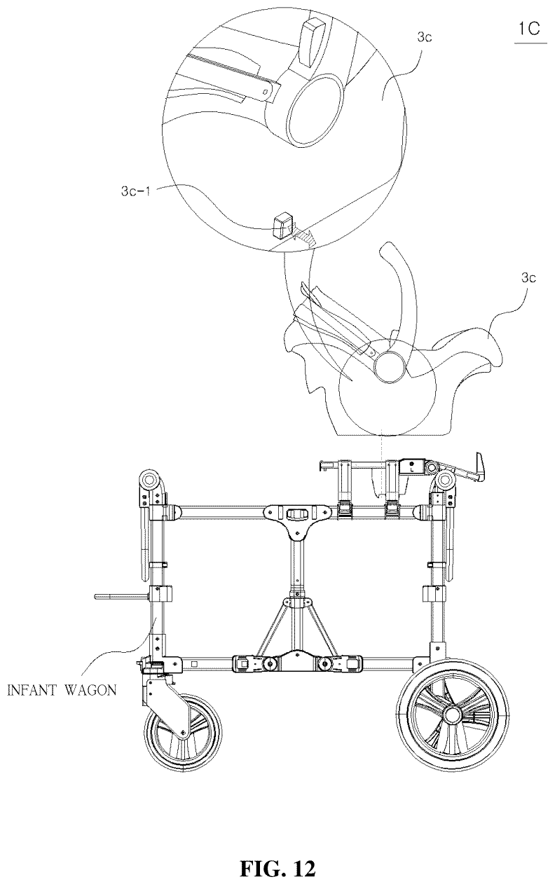

FIG. 13 is a side view showing a state in which the car seat adaptor according to the present invention is installed on the infant wagon and the C-type infant car seat is coupled to the car seat adapter, with an isometric partial enlarged view showing a state before the fastening protrusion of the C-type infant car seat is inserted into a C-type fastening recess of the center coupling frame;

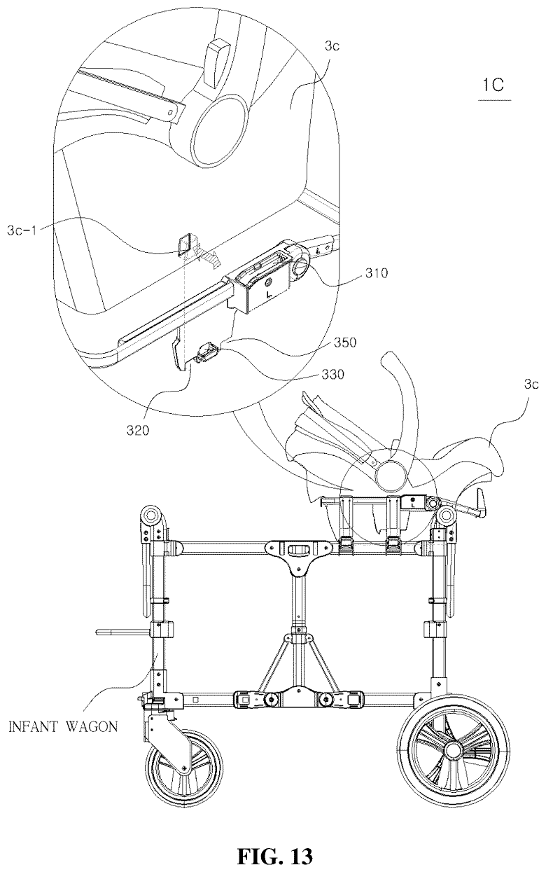

FIG. 14 is a side view showing a state in which the car seat adaptor according to the present invention is installed on the infant wagon and the C-type infant car seat is coupled to the car seat adapter, with an isometric partial enlarged view showing that the fastening protrusion of the C-type infant car seat is inserted into the C-type fastening recess of the center coupling frame;

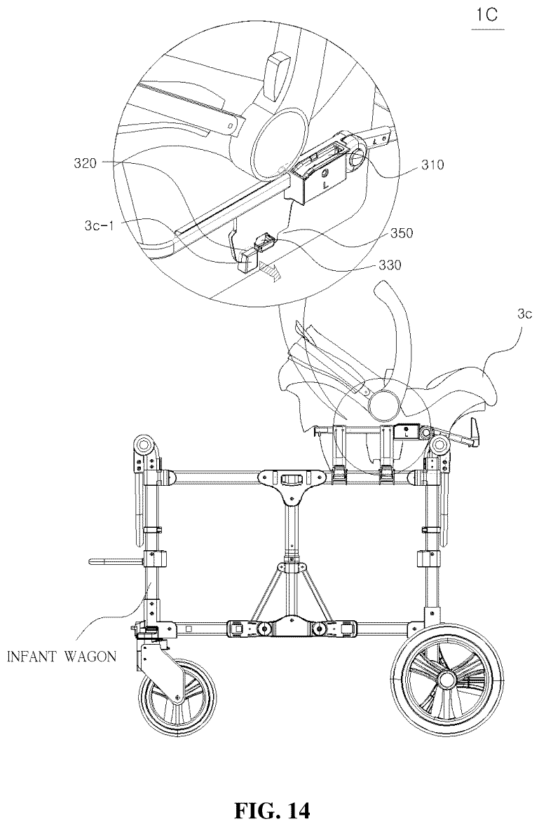

FIG. 15 is a side view showing a state in which the car seat adaptor according to the present invention is installed on the infant wagon and the C-type infant car seat is coupled to the car seat adapter, with a partial enlarged view showing a state in which the female buckle and the male buckle are not fastened to each other;

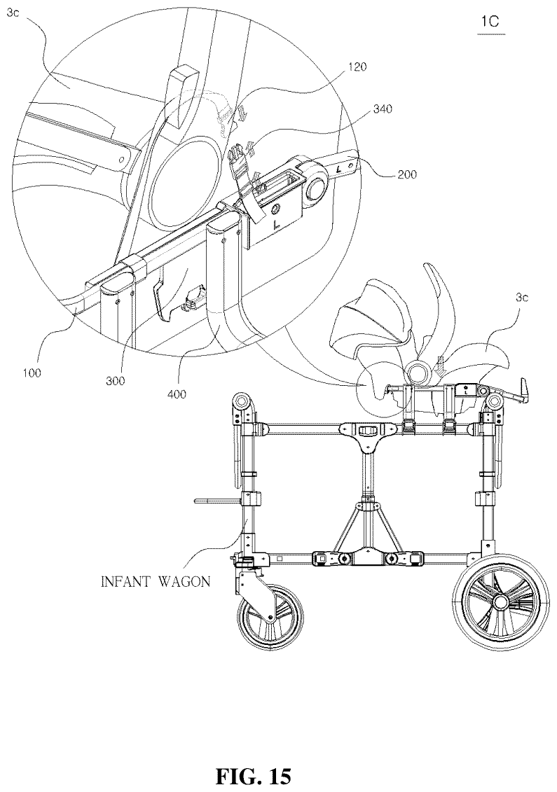

FIG. 16 is a side view showing a state in which the car seat adaptor according to the present invention is installed on the infant wagon and the C-type infant car seat is coupled to the car seat adapter, with a partial enlarged view showing a state in which the female buckle and the male buckle are fastened to each other;

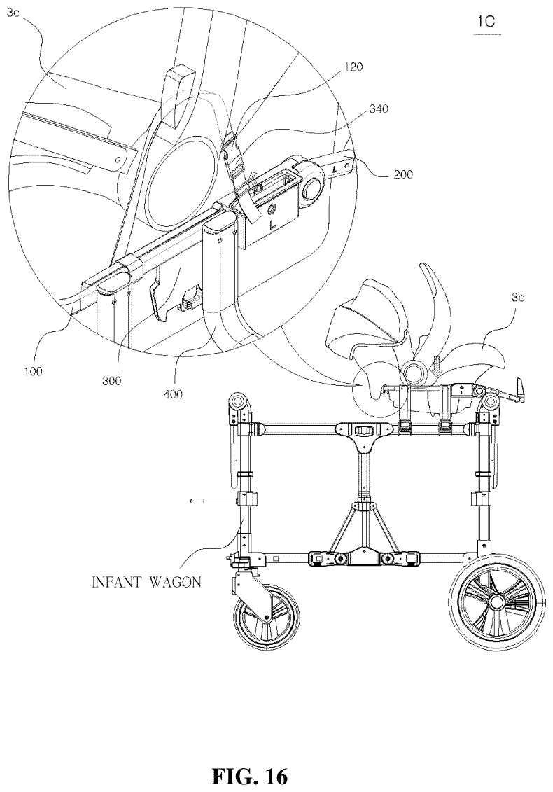

FIG. 17 is a side view showing a state in which the car seat adaptor according to the present invention is installed on the infant wagon and a D-type infant car seat is not coupled to the car seat adapter, with a partial enlarged view showing the parts couplable to each other;

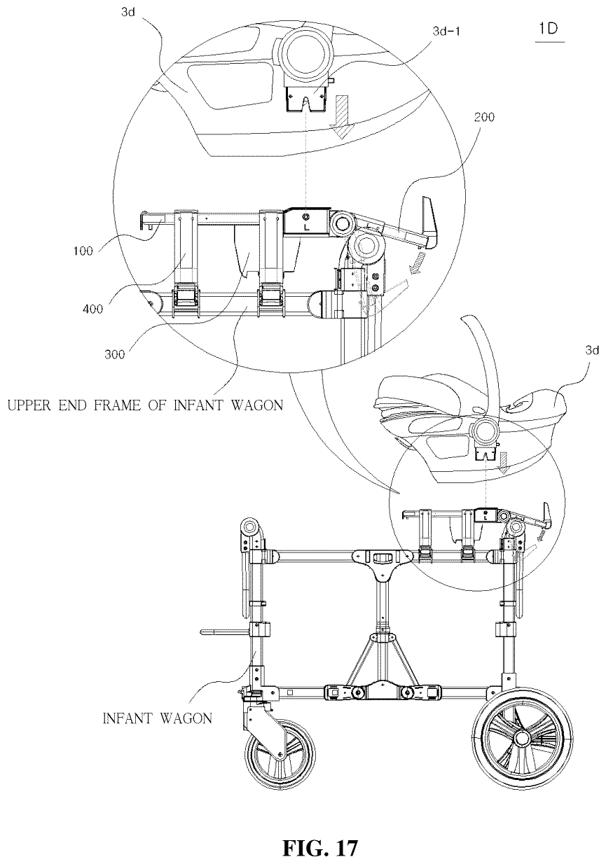

FIG. 18 is a side view showing a state in which the car seat adaptor according to the present invention is installed on the infant wagon and the D-type infant car seat is coupled to the car seat adapter, with a partial projected enlarged view showing the parts coupled to each other;

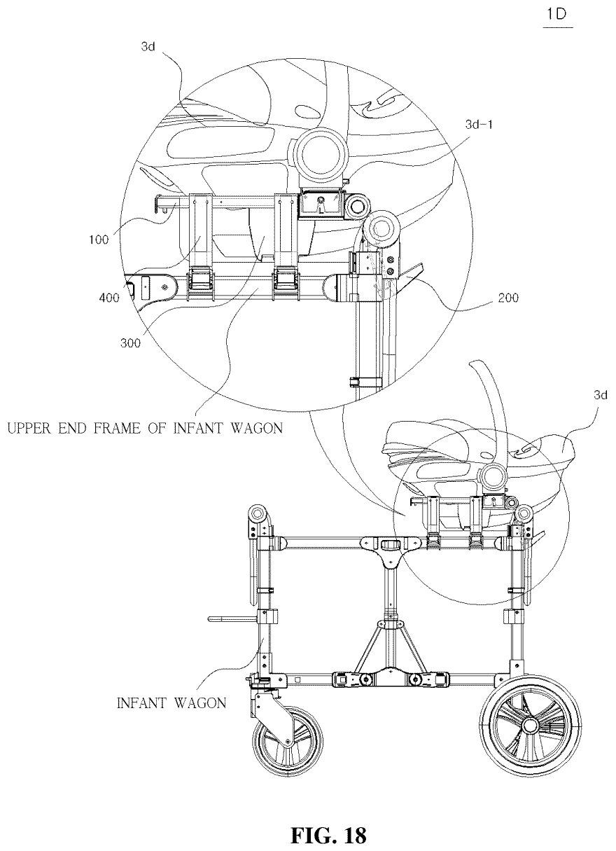

FIG. 19 is a side view showing a state in which the car seat adaptor according to the present invention is installed on the infant wagon and the D-type infant car seat is coupled to the car seat adapter, with an isometric partial enlarged view showing the parts coupled to each other;

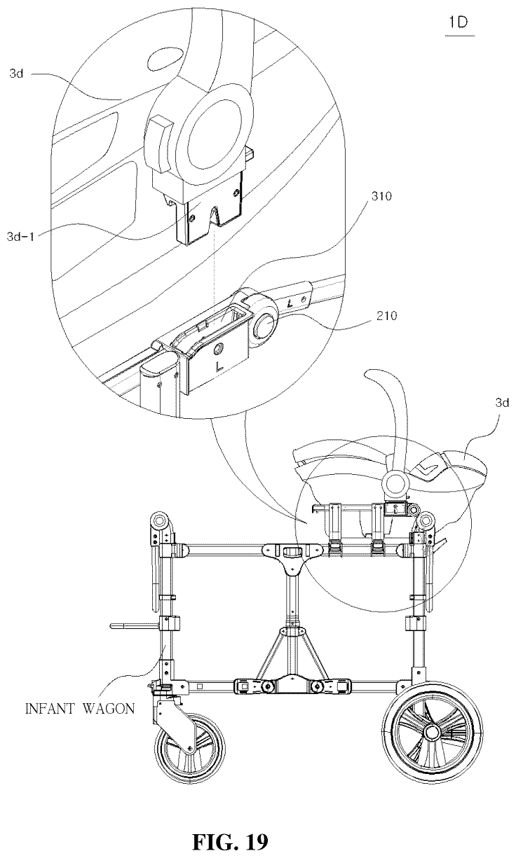

FIG. 20 is a side view showing a state in which the car seat adaptor according to the present invention is installed on the infant wagon and an E-type infant car seat is not coupled to the car seat adapter, with a partial enlarged view showing parts couplable to each other;

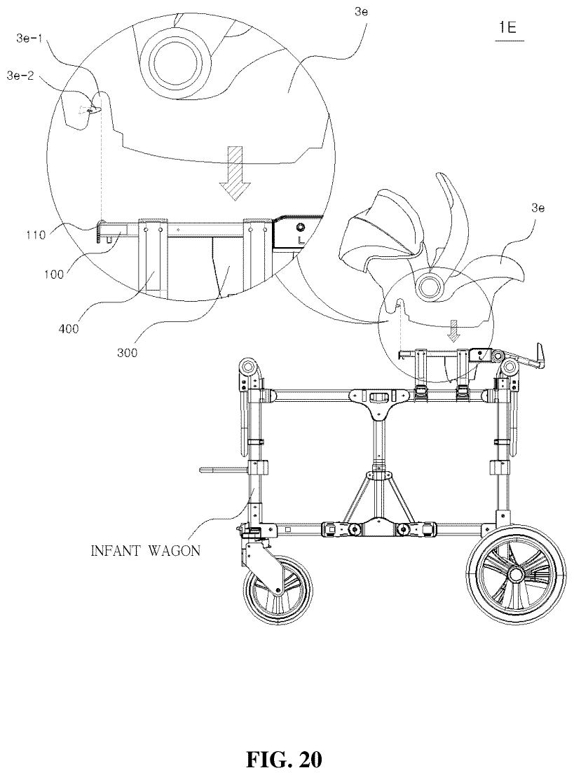

FIG. 21 is a side view showing a state in which the car seat adaptor according to the present invention is installed on the infant wagon and the E-type infant car seat is coupled to the car seat adapter, with a partial projected enlarged view showing the parts coupled to each other;

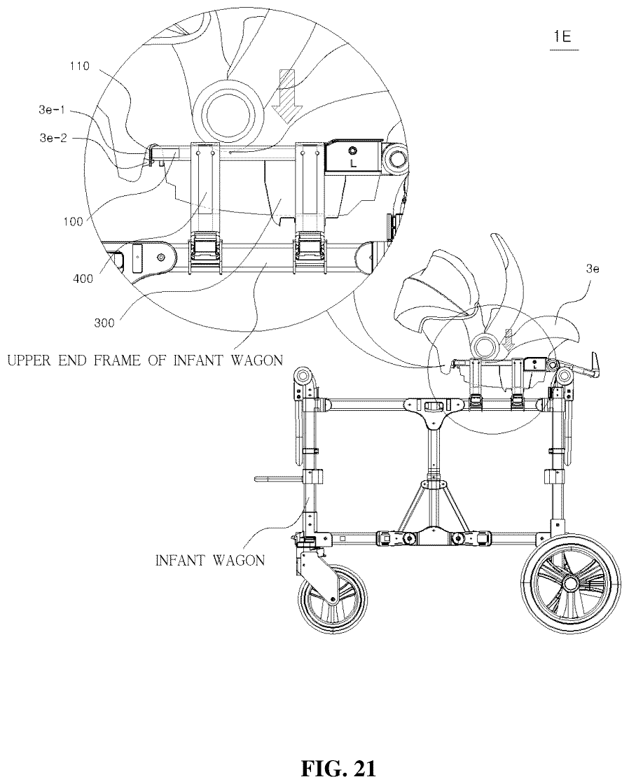

FIG. 22 is a side view showing a state in which the car seat adaptor according to the present invention is installed on the infant wagon and the E-type infant car seat is coupled to the car seat adapter, with an isometric partial enlarged view showing the parts coupled to each other;

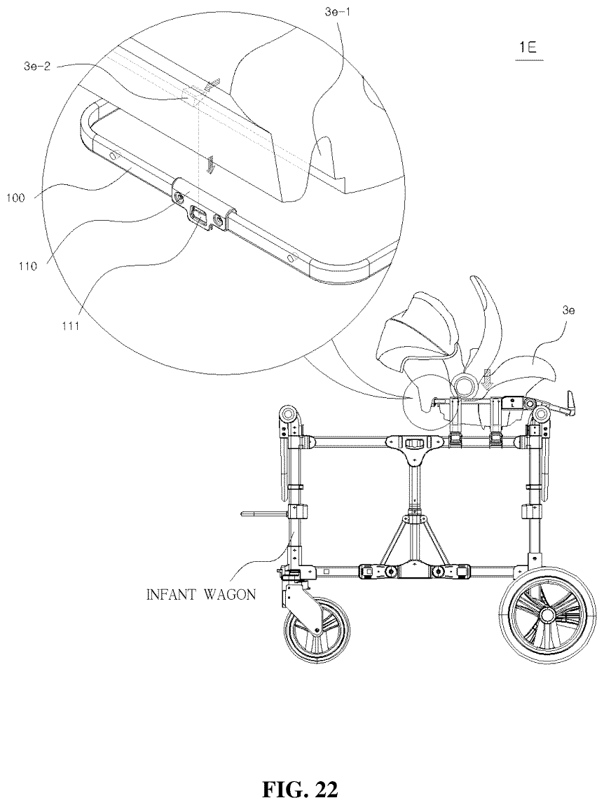

FIG. 23 is a side view showing a state in which the car seat adaptor according to the present invention is installed on the infant wagon and the E-type infant car seat is coupled to the car seat adapter, with a partial enlarged view showing a state in which the female buckle and the male buckle are not fastened to each other;

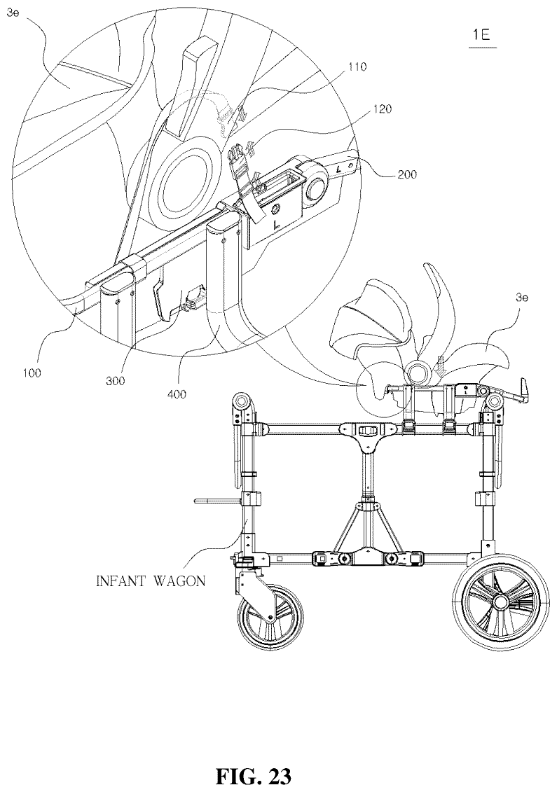

FIG. 24 is a side view showing a state in which the car seat adaptor according to the present invention is installed on the infant wagon and the E-type infant car seat is coupled to the car seat adapter, with a partial enlarged view showing a state in which the female buckle and the male buckle are fastened to each other;

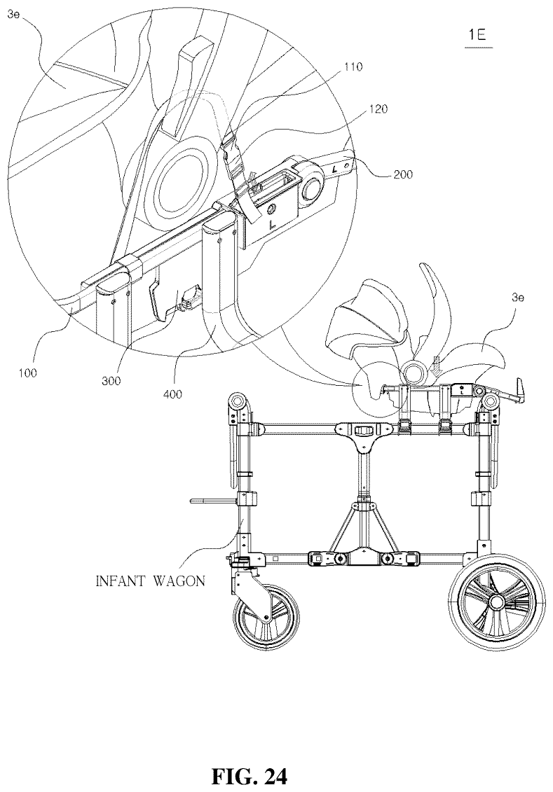

FIG. 25 is a side view showing a state in which the car seat adaptor according to the present invention is installed on the infant wagon and an F-type infant car seat is not coupled to the car seat adapter, with an isometric partial enlarged view showing a fastening protrusion of the F-type infant car seat;

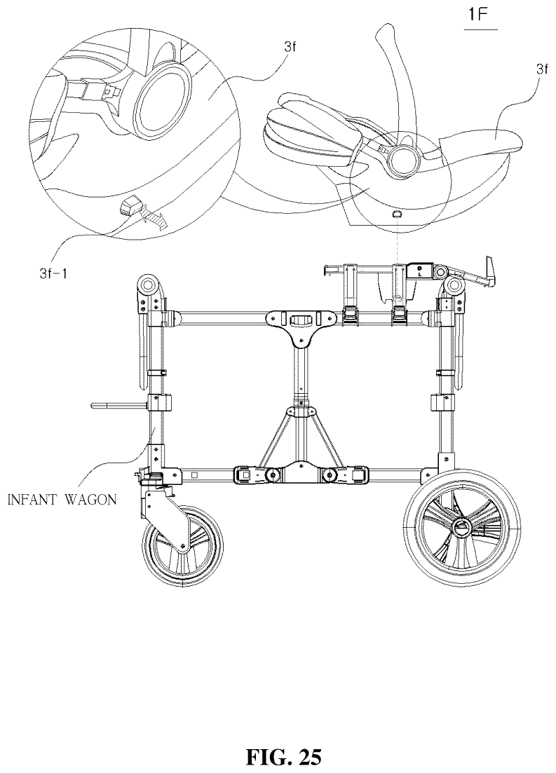

FIG. 26 is a side view showing a state in which the car seat adaptor according to the present invention is installed on the infant wagon and the F-type infant car seat is coupled to the car seat adapter, with an isometric partial enlarged view showing a state before the fastening protrusion of the F-type infant car seat is inserted into an F-type fastening recess of the center coupling frame;

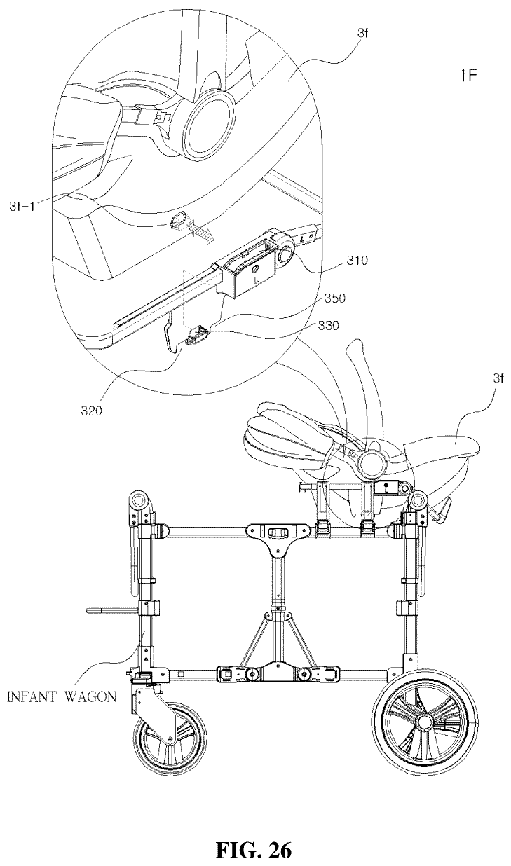

FIG. 27 is a side view showing a state in which the car seat adaptor according to the present invention is installed on the infant wagon and the F-type infant car seat is coupled to the car seat adapter, with an isometric partial enlarged view showing a state in which the fastening protrusion of the F-type infant car seat is inserted into the F-type fastening recess of the center coupling frame;

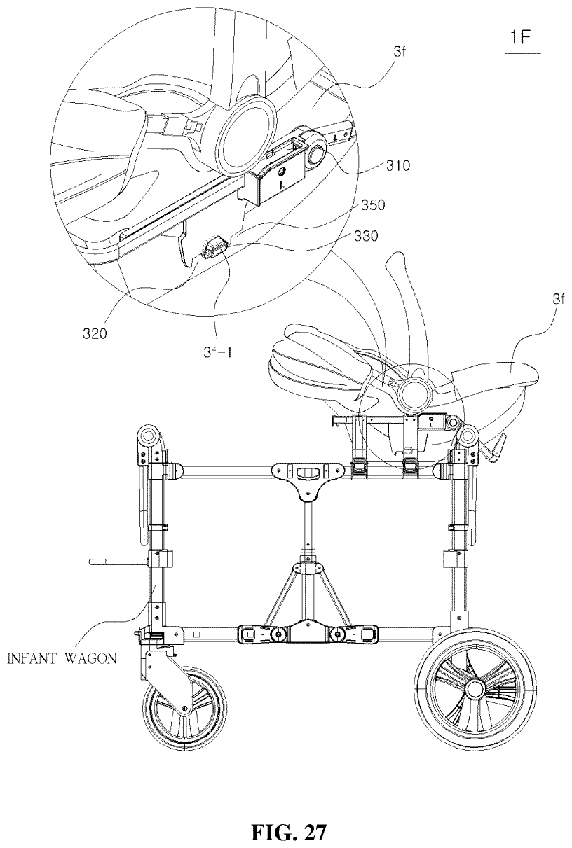

FIG. 28 is a side view showing a state in which the car seat adaptor according to the present invention is installed on the infant wagon, and the connection bracket and a G-type infant car seat are not coupled to the car seat adapter, with a partial enlarged view showing the parts couplable to each other;

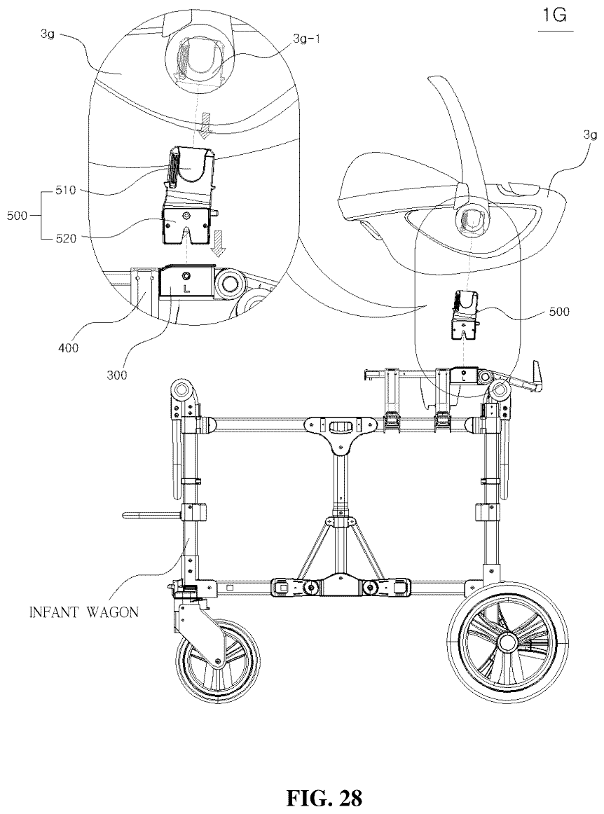

FIG. 29 is a side view showing a state in which the car seat adaptor according to the present invention is installed on the infant wagon, and the connection bracket and the G-type infant car seat are coupled to the car seat adapter, with a partial projected enlarged view showing the parts coupled to each other; and

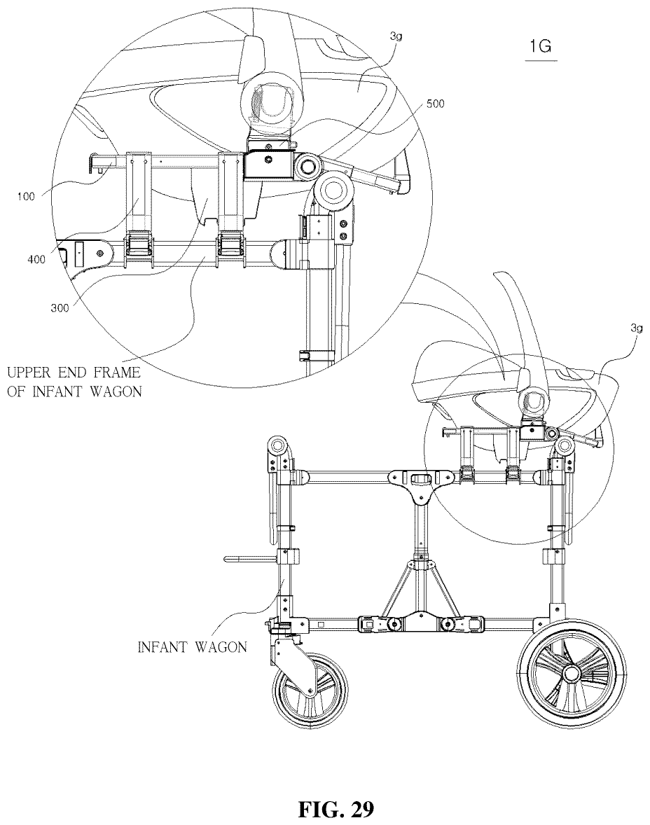

FIG. 30 is a side view showing a state in which the car seat adaptor according to the present invention is installed on the infant wagon, and the connection bracket and the G-type infant car seat are coupled to the car seat adapter, with an isometric partial enlarged view showing the parts coupled to each other.

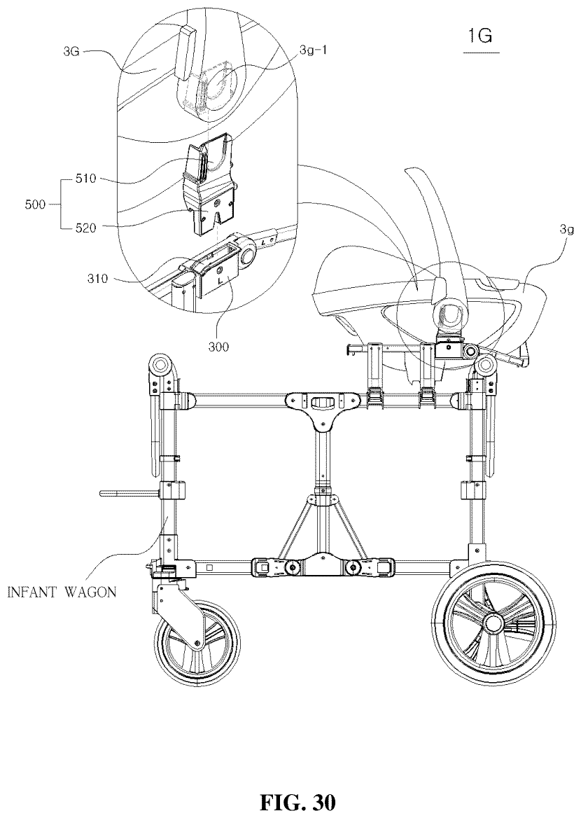

FIG. 31 is a side view showing a state in which the car seat adapter according to the present invention is installed rearward on an upper end of the infant wagon and a H-type infant car seat is not coupled to the car seat adapter, with an isometric partial enlarged view showing a fastening protrusion of the H-type infant car seat.

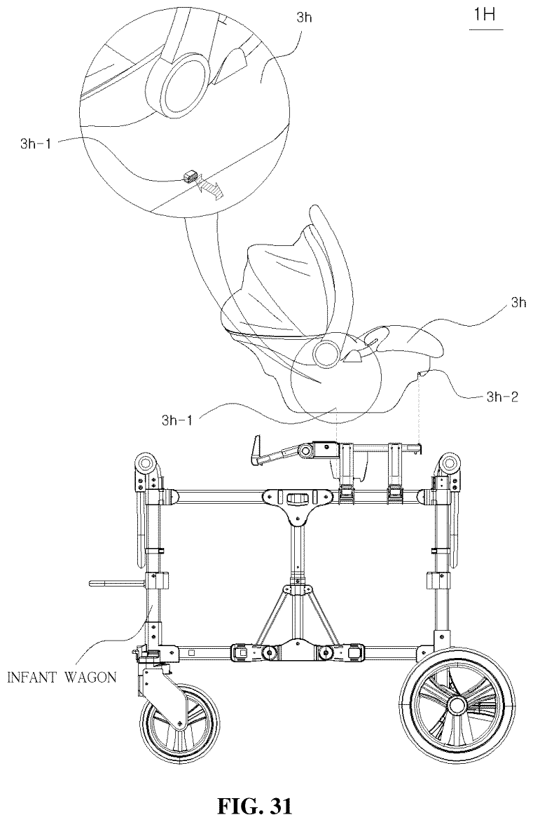

FIG. 32 is a side view showing a state in which the car seat adapter according to the present invention is installed rearward on the upper end of the infant wagon and the H-type infant car seat is coupled to the car seat adapter, with an isometric partial enlarged view showing a state before the fastening protrusion of the H-type infant car seat is inserted into an H-type fastening recess of the center coupling frame.

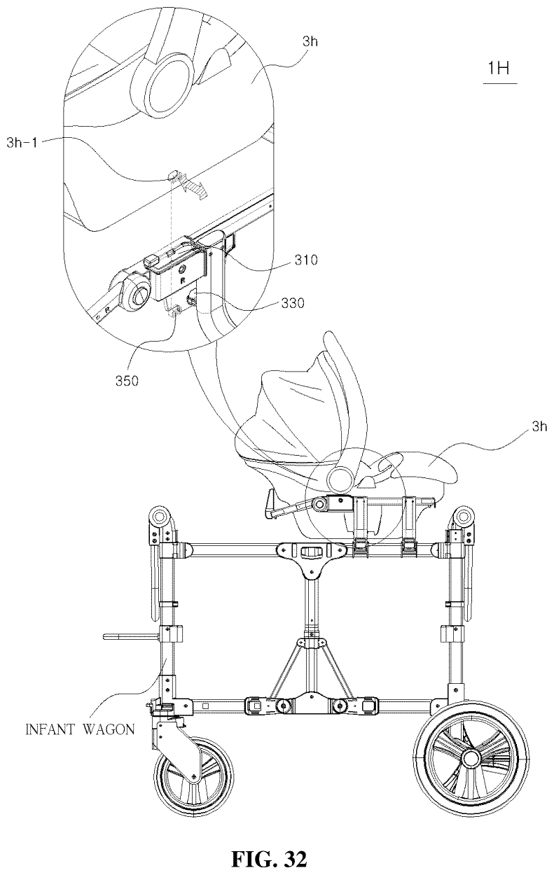

FIG. 33 is a side view showing a state in which the car seat adapter according to the present invention is installed rearward on the upper end of the infant wagon and the H-type infant car seat is coupled to the car seat adapter, with an isometric partial enlarged view showing a state in which the fastening protrusion of the H-type infant car seat is inserted into the H-type fastening recess of the center coupling frame.

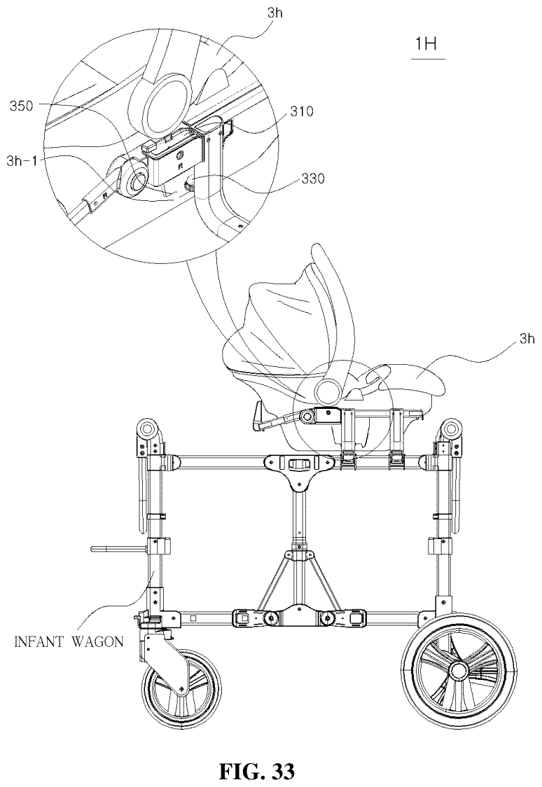

FIG. 34 is a side view showing a state in which the car seat adapter according to the present invention is installed rearward on the upper end of the infant wagon and the H-type infant car seat is not coupled to the car seat adapter, with a partial enlarged view showing the parts couplable to each other.

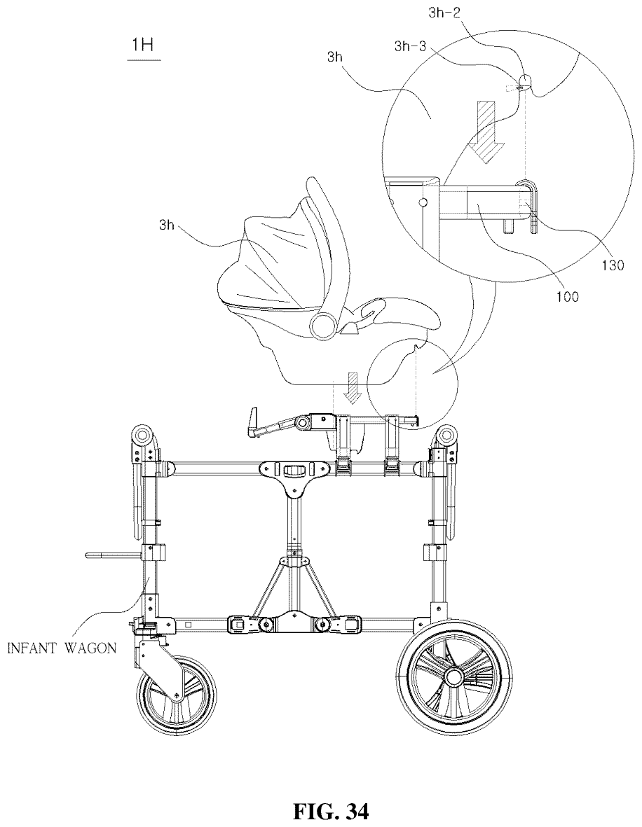

FIG. 35 is a side view showing a state in which the car seat adapter according to the present invention is installed rearward on the upper end of the infant wagon and the H-type infant car seat is coupled to the car seat adapter, with a partial projected enlarged view showing the parts coupled to each other.

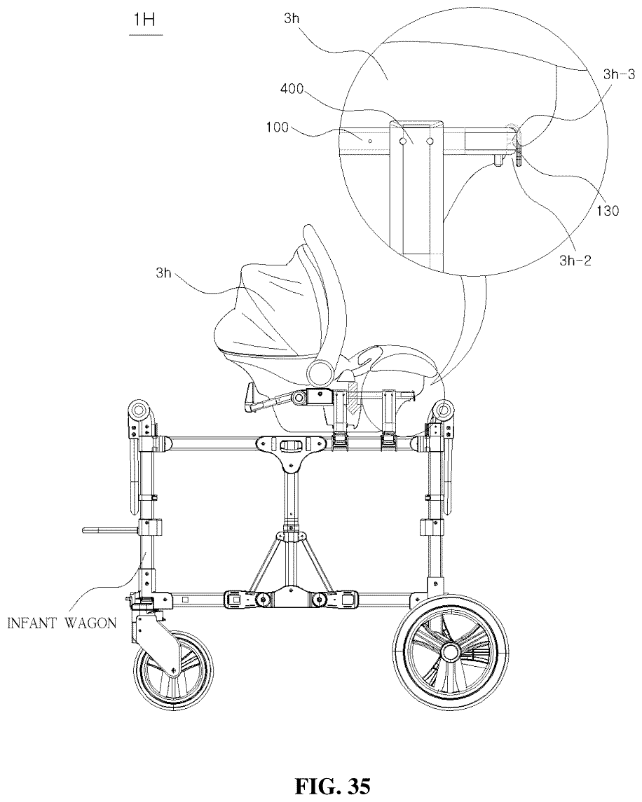

FIG. 36 is an isometric view showing a state in which the car seat adapter according to the present invention is installed rearward on the upper end of the infant wagon and the H-type infant car seat is coupled to the car seat adapter, with an isometric partial projected enlarged view showing the parts coupled to each other.

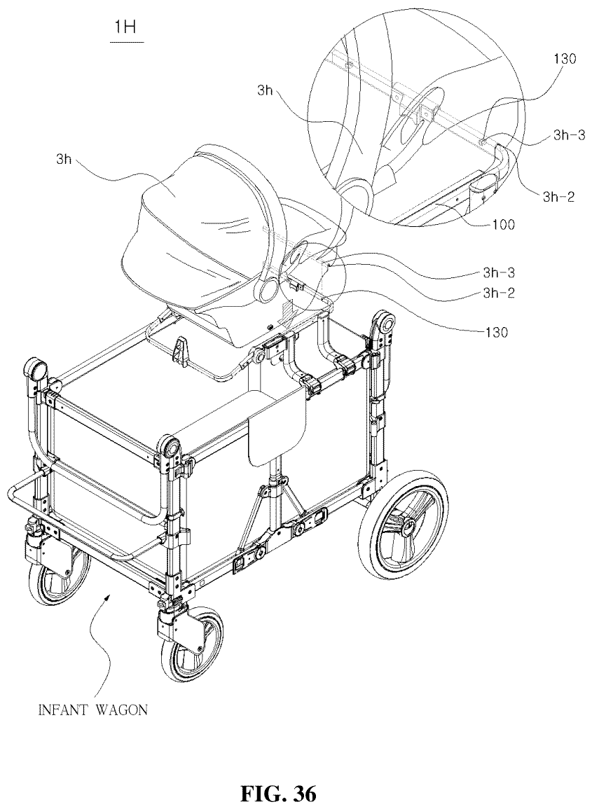

### DETAILED DESCRIPTION OF THE PRESENT INVENTION

Hereinafter, a preferred embodiment of the present invention will be described with reference to the accompanying drawings.

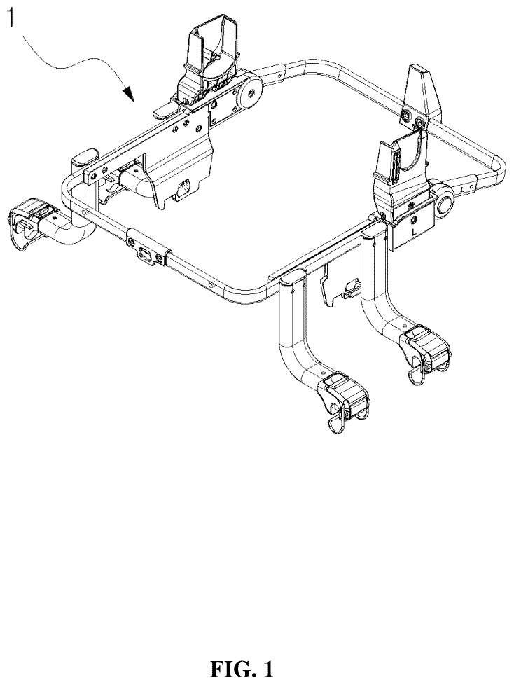

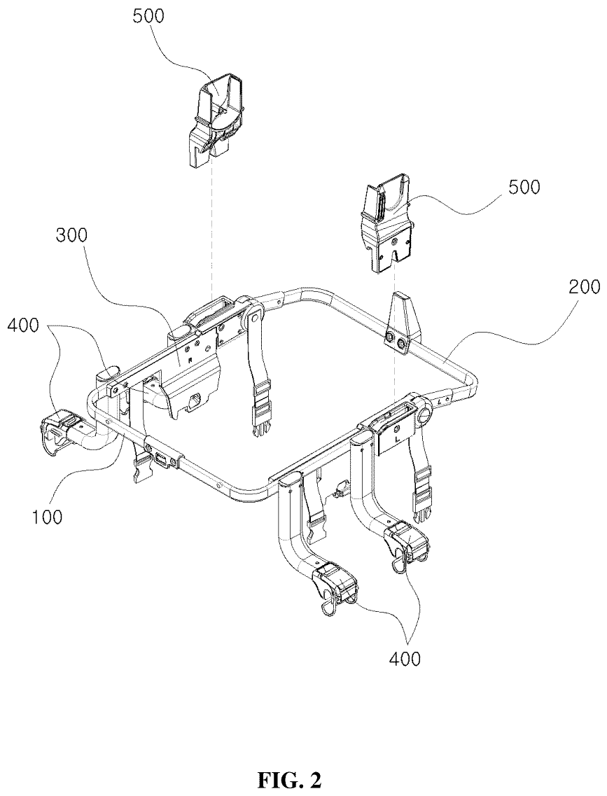

FIG. 1 is a perspective view showing an overall shape of a highly compatible car seat adapter 1 for wagons according to the present invention, and FIG. 2 is an exploded perspective view of the highly compatible car seat adapter for wagons according to the present invention with a connection bracket being separated from the other components of the car seat adapter.

The car seat adapter 1 according to the present invention is a frame which has a quadrangular frame structure with rounded corners, which is symmetrically coupled to the upper left and right ends of an infant wagon so as to have a coupling structure compatible with each of a plurality of different infant car seats, and which serves to stably support an infant car seat coupled to the infant wagon.

The car seat adapter 1 according to the present invention includes a front main stationary frame 100, a rear main rotating frame 200, a center coupling frame 300, and a lower end fastening frame 400.

First, the front main stationary frame 100 according to the present invention will be described.

The front main stationary frame 100 is a stationary frame that forms the front of the car seat adapter of the quadrangular frame structure, and serves to support the rear lower periphery of the infant car seat coupled in the reverse direction.

The front main stationary frame 100 includes a front clip 110 and a female buckle 120.

Here, the front clip 110 is configured to be inserted vertically into the front center of the front main stationary frame 100 and has a front fastening recess 111 formed in the front center thereof.

In this case, the front fastening recess 111 is configured to allow a lower end fastening protrusion 3e-2 of an E-type infant car seat to be separably inserted thereinto.

Here, the female buckle 120 is formed so as to be separably fastened to a male buckle 340 connected to a strap coupled to each of the left and right rear peripheries of the center coupling frame.

In this case, the female buckle 120 and the male buckle 340 wrap around each of the left and right sides of the center handle of the type-specific infant car seat and are configured to be tightened through a length adjustment buckle formed at one side of each strap to stably fix the infant car seat.

In addition, according to this present invention, an H-type ring groove 130 is formed symmetrically at left and right front sides of the front main stationary frame 100.

In this case, the H-type ring groove 130 is configured to be inserted into a lower end fastening protrusion 3h-3 disposed at each of left and right inner sides of a front lower end recess 3h-2 of the H-type car seat.

Next, the rear main rotating frame 200 according to the present invention will be described.

The rear main rotating frame 200 is a rotating frame that forms the rear of the car seat adapter of the quadrangular frame structure, and serves to support the front lower periphery of the infant car seat coupled in the reverse direction.

The rear main rotating frame 200 includes a rotation switch 210 and a truncated-quadrangular-pyramid-shaped fitting frame 220.

Here, the rotation switch 210 is a switch formed at the outer surface of each of the front left and right ends of the main rotation frame, and serves to set the fixed angle of the rear main rotating frame 200 which is coupled to the rear left and right sides of the center coupling frame 300 through a rotary shaft.

Here, in a state in which the rotation switches 210 formed at the left and right sides are simultaneously pressed, the angle of the rear main rotating frame may be set relative to the rotary shaft, and when the rotation switches are released, the rotary shaft is locked and the rear main rotating frame is fixed.

Here, the truncated-quadrangular-pyramid-shaped fitting frame 220 is a frame protruding from the rear center of the main rotation frame in an upward direction in the shape of a truncated quadrangular pyramid, is rotated by the rotation switch when a recess is formed in the front lower end of the type-specific infant car seat coupled to the car seat adapter depending on the structure of the front lower end, and is inserted into the front lower end of the infant car seat to fix the infant car seat such that the infant car seat is stably supported.

Next, the center coupling frame 300 according to the present invention will be described.

The center coupling frame 300 has a left-right symmetrical structure and is configured such that one side of the front of the center coupling frame is fixed and coupled to each of the left and right inner surfaces of the front main stationary frame and one side of the rear of the center coupling frame is rotatably coupled to each of the left and right inner surfaces of the rear main rotating frame.

The center coupling frame 300 includes a bracket insertion recess 310, a C-type fastening recess 320, an F-type fastening recess 330, and a male buckle 340.

Here, the bracket insertion recess 310 is an insertion recess formed at one end of the rear upper side of the center coupling frame in a vertical direction, and is formed so as to have a structure that engages with a lower end fitting coupling portion 520 of the connection bracket 500.

In this case, the bracket insertion recess 310 is formed such that the connection bracket 500 can be easily separably inserted into the disengaged bracket insertion recess, whereby the connection bracket may be separably inserted into the bracket insertion recess depending on the coupling structure of the type-specific infant car seat.

Here, the C-type fastening recess 320 is a quadrangular recess formed at one side of the front of the lower end surface of the frame formed at the inner surface of the center coupling frame in an upward direction, and is formed so as to have a structure that engages with a fastening protrusion 3c-1 when a C-type infant car seat is coupled.

Here, the F-type fastening recess 330 is a recess protruding from one side of the center of the lower end of the frame formed at the inner surface of the center coupling frame in an outward direction while the inside of the protrusion is hollow, and is formed so as to have a structure that engages with a fastening protrusion 3f-1 when an F-type infant car seat is coupled.

Here, the male buckle 340 is coupled to each of the left and right rear peripheries of the center coupling frame, and is formed so as to be separably fastened to the female buckle 120 of the front main stationary frame.

In this case, when fastened to the female buckle 120, the male buckle 340 wraps around each of the left and right sides of a center handle of the type-specific infant car seat and is tightened through the length adjustment buckle formed at one side of each strap to stably fix the infant car seat.

In addition, according to this present invention, the center coupling frame 300 may include a H-type protrusion fastening groove 350.

Here, the H-type protrusion fastening groove 350 is a groove cut at a right angle (90 degrees) on one side of the rear lower surface of the frame formed on the inner side of the center coupling frame, and the H-type protrusion fastening groove 350 is configured in a structure that engages the fastening protrusion 3h-1 when the H-type infant car seat is coupled.

Next, the lower end fastening frame 400 according to the present invention will be described.

The lower end fastening frame 400 comprises lower end support frames formed at the front and the rear of the lower end of the outer surface of the front main stationary frame so as to have a left-right symmetrical structure, and a fastening structure is formed at one side of the lower end of each lower end support frame so as to be coupled to each of the left and right sides of the upper end frame of the infant wagon.

The lower end fastening frame 400 includes a locking button 410, a locking switch 420, and a fastening hook 430.

Here, the locking button 410 is a button protruding rearward from the rear surface of the lower end fastening frame, and is configured to lock and unlock the locking switch.

In this case, pressing the locking button 410 allows the locking switch 420 to be pulled up or pulled down, and releasing the pressed locking button locks the locking switch 420.

Here, the locking switch 420 is a switch formed at the upper end of the lower end fastening frame, and is configured such that, when the locking switch is pulled up toward an upward-outer direction and rotated in a state in which the locking button 410 is released, the fastening hook formed at the lower end is unlocked and opened.

Here, the fastening hook 430 is a hook that is coupled to the left and right side surfaces of the locking switch 420 and is formed in a downward direction, and serves to couple the car seat adapter to the infant wagon.

The fastening hooks 430 are disposed left-right symmetrically at the front and rear so as to allow the car seat adapter to be stably fixed to the infant wagon while wrapping around the upper end frame of the infant wagon when fastened, and allow the car seat adapter to be separated from the infant wagon when released.

As such, the lower end fastening frame 400 according to the present invention has a double-locking structure in which the locking button 410 is firstly pressed and the locking switch 420 is secondly pulled up toward an upward-outer direction and rotated, whereby the rotational lock of the fastening hook may be released, and therefore the fastening hook is not opened even if the locking button is unintentionally pressed.

This prevents unintentional detachment of the car seat adapter from the infant wagon even if the locking button is pressed by a mistake of an infant or a caregiver or by external force, thereby ensuring safety.

In addition, the car seat adapter 1 according to the present invention may further include a connection bracket 500.

The connection bracket 500 is configured to be vertically fitted into and coupled to the upper end of the center coupling frame 300 having the left-right symmetrical structure in a state in which the connection bracket 500 has a left-right symmetrical structure.

The connection bracket 500 is configured to be separably coupled to the infant car seat depending on the coupling structure of the type-specific infant car seat.

The connection bracket 500 includes an upper end fitting coupling portion 510 and a lower end fitting coupling portion 520.

Here, the upper end fitting coupling portion 510 is a frame forming an upper end of the connection bracket, and has a structure that engages with an upper end insertion recess 3g-1 formed in a lower end of each of the left and right side surfaces of a G-type infant car seat in an upward direction.

Here, the lower end fitting coupling portion 520 is a frame forming a lower end of the connecting frame, and has a structure that engages with the bracket insertion recess 310 of the center coupling frame 300.

In addition, the car seat adapter 1 according to the present invention is characterized in that the car seat adapter has a coupling structure compatible with each of a plurality of different infant car seats and stably supports the infant car seat coupled to the infant wagon.

The coupling structure includes an A-type coupling structure 1A, a B-type coupling structure 1B, a C-type coupling structure 1C, a D-type coupling structure 1D, an E-type coupling structure 1E, an F-type coupling structure 1F, a G-type coupling structure 1G, and a H-type coupling structure 1H.

The A-type coupling structure 1A is configured such that the infant car seat is seated inside the front main stationary frame, the rear main rotating frame, and the center coupling frame, whereby primary coupling is achieved, the female buckle 120 connected to the strap coupled to each of the left and right front peripheries of the front main stationary frame and the male buckle 340 connected to the strap coupled to each of the left and right rear peripheries of the center coupling frame are fastened to each other at each of the left and right sides of the center handle of the A-type infant car seat, and the straps of the female and male buckles are tightened through the length adjustment buckle formed at one side of each strap, whereby secondary coupling is achieved, and therefore the A-type infant car seat is couplable to the infant wagon.

The B-type coupling structure 1B is configured such that the rotation switch 210 formed at each of the left and right rotary shafts of the rear main rotating frame is pressed to rotate the rear main rotating frame 200 in the downward direction, the B-type infant car seat is located inside the front main stationary frame and the center coupling frame, and the lower end fitting coupling portion 3b-1 formed at each of the left and right sides of the infant car seat in the downward direction is inserted into the bracket insertion recess 310 formed in the inner surface of the center coupling frame, whereby the B-type infant car seat is couplable to the infant wagon.

The C-type coupling structure 1C is configured such that the C-type infant car seat 3c is located inside the front main stationary frame, the rear main rotating frame, and the center coupling frame, the fastening protrusion 3c-1 formed at one side of the lower end of each of the left and right surfaces of the C-type infant car seat is primarily fitted into and coupled to the C-type fastening recess 320 of the connection bracket 500, the female buckle 120 connected to the strap coupled to each of the left and right front peripheries of the front main stationary frame and the male buckle 340 connected to the strap coupled to each of the left and right rear peripheries of the center coupling frame are fastened to each other at each of the left and right sides of the center handle of the C-type infant car seat, the straps of the female and male buckles are tightened through the length adjustment buckle formed at one side of each strap, whereby secondary coupling is achieved, and therefore the C-type infant car seat is couplable to the infant wagon.

The D-type coupling structure 1D is configured such that the rotation switch 210 formed at each of the left and right rotary shafts of the rear main rotating frame is pressed to rotate the rear main rotating frame 200 in the downward direction, the D-type infant car seat is located inside the front main stationary frame and the center coupling frame, and the lower end fitting coupling portion 3d-1 formed at each of the left and right sides of the infant car seat in the downward direction is inserted into and coupled to the bracket insertion recess 310 formed in the inner surface of the center coupling frame, whereby the D-type infant car seat is couplable to the infant wagon.

The E-type coupling structure 1E is configured such that the E-type infant car seat is located inside the front main stationary frame, the rear main rotating frame, and the center coupling frame, one side of the front center of the front main stationary frame is inserted into the rear lower end recess 3e-1 of the E-type infant car seat, the lower end fastening protrusion 3e-2 formed at one side of the center of the rear lower end recess is inserted into the front fastening recess 111 of the front clip 110 formed at the front center of the front main stationary frame, whereby primary coupling is achieved, the female buckle 120 connected to the strap coupled to each of the left and right front peripheries of the front main stationary frame and the male buckle 340 connected to the strap coupled to each of the left and right rear peripheries of the center coupling frame are fastened to each other at each of the left and right sides of the center handle of the C-type infant car seat, the straps of the female and male buckles are tightened through the length adjustment buckle formed at one side of each strap, whereby secondary coupling is achieved, and therefore the E-type infant car seat is couplable to the infant wagon.

The F-type coupling structure 1F is configured such that the F-type infant car seat 3f is located inside the front main stationary frame, the rear main rotating frame, and the center coupling frame, the fastening protrusion 3f-1 formed at one side of the lower end of each of the left and right surfaces of the F-type infant car seat is primarily fitted into and coupled to the F-type fastening recess 330 of the connection bracket 500, the female buckle 120 connected to the strap coupled to each of the left and right front peripheries of the front main stationary frame and the male buckle 340 connected to the strap coupled to each of the left and right rear peripheries of the center coupling frame are fastened to each other at each of the left and right sides of the center handle of the F-type infant car seat, the straps of the female and male buckles are tightened through the length adjustment buckle formed at one side of each strap, whereby secondary coupling is achieved, and therefore the F-type infant car seat is couplable to the infant wagon.

The G-type coupling structure 1G is configured such that the lower end of the connection bracket 500 is inserted into and coupled to the bracket insertion recess of the center coupling frame 300, the G-type infant car seat is located inside the front main stationary frame, the rear main rotating frame, and the center coupling frame, and the upper end of the connection bracket 500 is fitted into and coupled to the upper end insertion recess 3g-1 formed in the lower end of each of the left and right side surfaces of the G-type infant car seat in the upward direction, whereby the G-type infant car seat is couplable to the infant wagon.

The H-type coupling structure 1H is configured such that the front of the car seat adapter is coupled to the upper end of the infant wagon in a rearward direction, and the H-type infant car seat 3h is located inside the front main stationary frame, the rear main rotating frame, and the center coupling frame, and a fastening protrusion 3h-1 formed at one side of a lower end of each of left and right surfaces of the H-type infant car seat is fitted into and coupled to an H-type protrusion fastening recess 350 of the connection bracket 500, whereby primary coupling is achieved, and one side of a front center of the front main stationary frame is inserted into a front lower end recess 3h-2 of the H-type infant car seat, and a lower end fastening protrusion 3h-3 formed at one side of each of left and right sides of the front lower end recess is inserted into a H-type ring coupling groove 130 formed left-right symmetrically at a front of the front main stationary frame, whereby secondary coupling is achieved, and therefore, the H-type infant car seat is couplable to the infant wagon.

As such, the car seat adapter according to the present invention is capable of selectively adopting the A-type coupling structure 1A, the B-type coupling structure 1B, the C-type coupling structure 1C, the D-type coupling structure 1D, the E-type coupling structure 1E, the F-type coupling structure 1F, the G-type coupling structure 1G, and the H-type coupling structure depending on the shape of the coupling parts of infant car seats of various structures distributed in the market, whereby the car seat adapter has excellent compatibility.

Hereinafter, the operation of the highly compatible car seat adapter for wagons according to the present invention will be described in detail.

First, the car seat adapter includes the front main stationary frame, the rear main rotating frame, the center coupling frame, and the lower end fastening frame, and the car seat adapter is coupled to the upper end of the infant wagon.

At this time, the locking button of each of four parts of the lower end fastening frame provided at the front and the rear so as to have the left-right symmetrical structure, the locking switch is pulled to open the fastening hook, and the lower end fastening frame is coupled to the upper end frame of the infant wagon.

Next, the coupling part of the infant car seat to be coupled to the car seat adapter is checked, and then the infant car seat is coupled to the car seat adapter.

For the A-type infant car seat, the A-type infant car seat is seated inside the front main stationary frame, the rear main rotating frame, and the center coupling frame, whereby primary coupling is achieved, the female buckle and the male buckle are fastened to each other, and the straps of the female and male buckles are tightened through the length adjustment buckle formed at one side of each strap, whereby secondary coupling is achieved.

For the B-type infant car seat, the rotation switch formed at each of the left and right rotary shafts of the rear main rotating frame is pressed to rotate the rear main rotating frame in the downward direction, the B-type infant car seat is located inside the front main stationary frame and the center coupling frame, and the lower end fitting coupling portion formed at each of the left and right sides of the infant car seat in the downward direction is inserted into and coupled to the bracket insertion recess formed in the inner surface of the center coupling frame.

For the C-type infant car seat, the C-type infant car seat is located inside the front main stationary frame, the rear main rotating frame, and the center coupling frame, the fastening protrusion formed at one side of the lower end of each of the left and right surfaces of the C-type infant car seat is primarily fitted into and coupled to the C-type fastening recess of the connection bracket, the female buckle and the male buckle are fastened to each other, and the straps of the female and male buckles are tightened through the length adjustment buckle formed at one side of each strap, whereby secondary coupling is achieved.

For the D-type infant car seat, the rotation switch formed at each of the left and right rotary shafts of the rear main rotating frame is pressed to rotate the rear main rotating frame in the downward direction, the D-type infant car seat is located inside the front main stationary frame and the center coupling frame, and the lower end fitting coupling portion formed at each of the left and right sides of the infant car seat in the downward direction is inserted into and coupled to the bracket insertion recess formed in the inner surface of the center coupling frame.

For the E-type infant car seat, the E-type infant car seat is located inside the front main stationary frame, the rear main rotating frame, and the center coupling frame, one side of the front center of the front main stationary frame is inserted into the rear lower end recess of the E-type infant car seat, and the lower end fastening protrusion formed at one side of the center of the rear lower end recess is inserted into the front fastening recess of the front clip formed at the front center of the front main stationary frame, whereby primary coupling is achieved, the female buckle and the male buckle are fastened to each other, and the straps of the female and male buckles are tightened through the length adjustment buckle formed at one side of each strap, whereby secondary coupling is achieved.

For the F-type infant car seat, the F-type infant car seat is located inside the front main stationary frame, the rear main rotating frame, and the center coupling frame, the fastening protrusion formed at one side of the lower end of each of the left and right surfaces of the F-type infant car seat is primarily fitted into and coupled to the F-type fastening recess of the connection bracket, the female buckle and the male buckle are fastened to each other, and the straps of the female and male buckles are tightened through the length adjustment buckle formed at one side of each strap, whereby secondary coupling is achieved.

For the G-type infant car seat, the lower end of the connection bracket is inserted into and coupled to the bracket insertion recess of the center coupling frame, the G-type infant car seat is located inside the front main stationary frame, the rear main rotating frame, and the center coupling frame, and the upper end of the connection bracket is fitted into and coupled to the upper end insertion recess formed in the lower end of each of the left and right side surfaces of the G-type infant car seat in the upward direction.

For the H-type infant car seat, the rear end of the car seat adapter is inserted into and coupled to the upper end of the infant wagon, the H-type infant car seat is located inside the front main stationary frame, the rear main rotating frame, and the center coupling frame, and a fastening protrusion formed at one side of a lower end of each of left and right surfaces of the H-type infant car seat is fitted into and coupled to the H-type protrusion fastening recess 350 of the connection bracket, whereby primary coupling is achieved, and one side of a front center of the front main stationary frame is inserted into a front lower end recess of the H-type infant car seat, and a lower end fastening protrusion 3h-3 formed at one side of each of left and right sides of the front lower end recess is inserted into a H-type ring coupling groove 130 formed left-right symmetrically at a front of the front main stationary frame, whereby secondary coupling is achieved.

As is apparent from the above description, a highly compatible car seat adapter for wagons according to the present invention is capable of stably coupling an infant car seat installed in a vehicle to an infant wagon upon arrival at a destination, whereby it is possible to provide the same ride comfort to an infant and to minimize resistance of the infant when the infant change from the vehicle to the infant wagon, which is enabled by mounting the infant car seat to an upper end of the infant wagon, and thus, it is possible to use the interior space of the infant wagon as a luggage carrier, which enables leisurely movement, and is compatible with each of a plurality of infant car seats having various shapes and coupling structures so as to be stably separably coupled to the infant wagon, whereby it is possible to expand usability of the infant car seat.

Although the preferred embodiments of the present invention have been disclosed for illustrative purposes, those skilled in the art will appreciate that various modifications, additions and substitutions are possible, without departing from the scope and spirit of the present invention as disclosed in the accompanying claims.

1. A compatible car seat adapter for wagons, comprising: a frame having a quadrangular frame structure with rounded corners, symmetrically couplable to upper left and right ends of an infant wagon; and a coupling structure compatible with an infant car seat and configured to stably support the infant car seat coupled to the infant wagon.

2. The compatible car seat adapter according to claim 1, wherein the frame comprises:
a front main stationary frame configured to support a rear lower periphery of the infant car seat couplable in a reverse direction;
a rear main rotating frame configured to support a front lower periphery of the infant car seat couplable in the reverse direction;
a center coupling frame having a left-right symmetrical structure, one side of a front of the center coupling frame being fixed and coupled to each of left and right inner surfaces of the front main stationary frame, and one side of a rear of the center coupling frame being rotatably coupled to each of left and right inner surfaces of the rear main rotating frame; and
a lower end fastening frame comprising lower end support frames formed at a front and a rear of a lower end of an outer surface of the front main stationary frame so as to have a left-right symmetrical structure, and a fastener formed at one side of a lower end of each of the lower end support frames so as to couple the lower end fastening frame to each of left and right sides of an upper end frame of the infant wagon.

3. The compatible car seat adapter according to claim 2, wherein the car seat adapter further comprises a connection bracket configured to be vertically fitted into and coupled to an upper end of the center coupling frame having the left-right symmetrical structure in a state in which the connection bracket has a left-right symmetrical structure.

4. The compatible car seat adapter according to claim 2, wherein the car seat adapter has an A-type coupling structure configured such that the infant car seat is seated inside the front main stationary frame, the rear main rotating frame, and the center coupling frame, whereby primary coupling is achieved, and a female buckle connected to a strap coupled to each of left and right front peripheries of the front main stationary frame and a male buckle connected to a strap coupled to each of left and right rear peripheries of the center coupling frame are configured to be fastened to each other at each of left and right sides of a center handle of an A-type infant car seat, and the straps of the female and male buckles are configured to be tightened through a length adjustment buckle formed at one side of each of the straps, whereby secondary coupling is achieved, and therefore the A-type infant car seat is couplable to the infant wagon.

5. The compatible car seat adapter according to claim 2, wherein the car seat adapter has a B-type coupling structure configured such that a rotation switch formed at each of the left and right rotary shafts of the rear main rotating frame is pressed to rotate the rear main rotating frame in a downward direction, and the B-type infant car seat is configured to be located inside the front main stationary frame and the center coupling frame, and a lower end fitting coupling portion formed at each of the left and right sides of the infant car seat in the downward direction is configured to be inserted into a bracket insertion recess formed in an inner surface of the center coupling frame, whereby the B-type infant car seat is couplable to the infant wagon.

6. The compatible car seat adapter according to claim 2, wherein the car seat adapter has a C-type coupling structure configured such that a C-type infant car seat is located inside the front main stationary frame, the rear main rotating frame, and the center coupling frame, and a fastening protrusion formed at one side of the lower end of each of left and right surfaces of the C-type infant car seat is fitted into and coupled to a C-type fastening recess of a connection bracket, whereby primary coupling is achieved, and a female buckle connected to a strap coupled to each of left and right front peripheries of the front main stationary frame and a male buckle connected to a strap coupled to each of left and right rear peripheries of the center coupling frame are configured to be fastened to each other at each of left and right sides of a center handle of the C-type infant car seat, and the straps of the female and male buckles are configured to be tightened through a length adjustment buckle formed at one side of each strap, whereby secondary coupling is achieved, and the C-type infant car seat is couplable to the infant wagon.

7. The compatible car seat adapter according to claim 2, wherein the car seat adapter has a D-type coupling structure configured such that a rotation switch formed at each of left and right rotary shafts of the rear main rotating frame is pressed to rotate the rear main rotating frame in a downward direction, and a D-type infant car seat is configured to be located inside the front main stationary frame and the center coupling frame, and a lower end fitting coupling portion formed at each of left and right sides of the infant car seat in the downward direction is configured to be inserted into and coupled to a bracket insertion recess formed in an inner surface of the center coupling frame, whereby the D-type infant car seat is couplable to the infant wagon.

8. The compatible car seat adapter according to claim 2, wherein the car seat adapter has an E-type coupling structure configured such that an E-type infant car seat is located inside the front main stationary frame, the rear main rotating frame, and the center coupling frame, one side of a front center of the front main stationary frame is inserted into a rear lower end recess of the E-type infant car seat, and a lower end fastening protrusion formed at one side of a center of the rear lower end recess is inserted into a front fastening recess of a front clip formed at the front center of the front main stationary frame, whereby primary coupling is achieved, and a female buckle connected to a strap coupled to each of left and right front peripheries of the front main stationary frame and a male buckle connected to a strap coupled to each of left and right rear peripheries of the center coupling frame are configured to be fastened to each other at each of left and right sides of a center handle of the E-type infant car seat, and the straps of the female and male buckles are configured to be tightened through a length adjustment buckle formed at one side of each of the straps, whereby secondary coupling is achieved, and the E-type infant car seat is couplable to the infant wagon.

9. The compatible car seat adapter according to claim 2, wherein the car seat adapter has an F-type coupling structure configured such that an F-type infant car seat is located inside the front main stationary frame, the rear main rotating frame, and the center coupling frame, and a fastening protrusion formed at one side of a lower end of each of left and right surfaces of the F-type infant car seat is fitted into and coupled to an F-type fastening recess of a connection bracket, whereby primary coupling is achieved, and a female buckle connected to a strap coupled to each of left and right front peripheries of the front main stationary frame and a male buckle connected to a strap coupled to each of left and right rear peripheries of the center coupling frame are configured to be fastened to each other at each of left and right sides of a center handle of the E-type infant car seat, and the straps of the female and male buckles are configured to be tightened through a length adjustment buckle formed at one side of each strap, whereby secondary coupling is achieved, and therefore the F-type infant car seat is couplable to the infant wagon.

10. The compatible car seat adapter according to claim 3, wherein the car seat adapter has a G-type coupling structure configured such that a lower end of the connection bracket is inserted into and coupled to a bracket insertion recess of the center coupling frame, a G-type infant car seat is located inside the front main stationary frame, the rear main rotating frame, and the center coupling frame, and an upper end of the connection bracket is fitted into and coupled to an upper end insertion recess formed in a lower end of each of left and right side surfaces of the G-type infant car seat in an upward direction, whereby the G-type infant car seat is couplable to the infant wagon.

11. The compatible car seat adapter according to claim 3,
wherein the front of the car seat adapter is couplable to an upper end of the infant wagon in a rearward direction, and
wherein the car seat adapter has an H-type coupling structure configured such that an H-type infant car seat is located inside the front main stationary frame, the rear main rotating frame, and the center coupling frame, and a fastening protrusion formed at one side of a lower end of each of left and right surfaces of the H-type infant car seat is fitted into and coupled to an H-type protrusion fastening recess of the connection bracket, whereby primary coupling is achieved, and one side of a front center of the front main stationary frame is inserted into a front lower end recess of the H-type infant car seat, and a lower end fastening protrusion formed at one side of each of left and right sides of the front lower end recess is inserted into a H-type ring coupling groove formed left-right symmetrically at a front of the front main stationary frame, whereby secondary coupling is achieved, and the H-type infant car seat is couplable to the infant wagon.
